(19) United States
(12) Patent Application Publication
(10) Pub. No.: US 2001/0038239 A1
(43) Pub. Date: Nov. 8, 2001

(54) Braking system with wireless communication capability and trailer including same

(76) Inventors: Donald J. Ehrlich, Lafayette, IN (US); James B. Brown JR., Lafayette, IN (US)

Correspondence Address: TREXLER, BUSHNELL, GIANGIORGI,, BLACKSTONE & MARR, LTD., 105 W. ADAMS STREET, CHICAGO, IL, 60603, US

(21) Appl. No.: 09/755,292

(22) Filed: Jan. 5, 2001

Related U.S. Application Data
(60) Provisional application No. 60/175,430, filed on Jan. 11, 2000.

(51) Int. Cl. B60T 13/66; B60T 13/68

(52) U.S. Cl. 303/20

(57) ABSTRACT

A braking system, such as an Anti-Lock Brake System (ABS) or Electropneumatic Braking System (EBS), which is configured to communicate information in a wireless transmission to a remote location. The braking system may be provided on a trailer, and may be configured to communicate the information to a fleet base. The information which is communicated to the fleet base may include information regarding tire pressure and bearing health, as well as other information about the trailer. The braking system includes an Electronic Control Module, and the Electronic Control Module may be connected to a communications antenna for transmitting the information to the fleet base, or may be in communication with a Trailer Tracking system on the trailer, where the Trailer Tracking system is configured to transmit the information to the fleet base.

### BACKGROUND OF THE INVENTION

This invention is generally directed to a novel braking system, such as an Anti-Lock Brake System (ABS) or Electropneumatic Braking System (EBS), which has wireless communication capability. As will be described, the braking system may be provided on a trailer.

Anti-lock brake systems (ABS) for air-braked truck trailers are in common use and generally include an Electronic Control Module (ECM), a Pneumatic Control Module (PCM) and wheel speed sensors. The various components may be known by different names, for example the ECM is sometimes called the Electronic Brake Control Unit or Electronic Control Unit(ECU). The PCM may be known as a modulator. Some ABS implementations integrate the PCM into another component known as the relay valve.

The wheel speed sensors provide wheel speed information to the ECM and the ECM signals the PCM to modify air pressure level at the brake chambers. This whole process controls the braking level so that the wheels continue to rotate, or at least rotate most of the time, even during heavy braking. The general configuration of ABS systems and their operation is well known in the art.

FIG. 1 illustrates a conventional trailer 10 which includes an ABS system. The trailer 10 is shown disengaged from a tractor, and includes a floor 12, a roof 14, side walls 16, a front wall 18, and doors (not specifically shown) which, when closed, define a rear wall 20. The trailer 10 includes rear wheels 22 that are engaged with a chassis (not specifically shown), hence the area in which the rear wheels are located is commonly referred to as the rear chassis area 24.

As shown, electronics 26, such as the ECM, generally associated with the ABS system are typically disposed near the rear of the trailer, proximate the rear chassis area 24. The location of the electronics 26 is dictated primarily by proximity to the pneumatic control portion (i.e., the PCM) of the ABS system and to the wheel speed sensors (not specifically shown in FIG. 1). Due to the location of the ABS electronics 26, ABS systems are well suited for monitoring conditions in the rear chassis area 24 of the trailer. In addition to wheel speed, an ABS system may be configured to monitor other things associated with the rear portion of the trailer, such as bearing health and tire pressure. U.S. Provisional Application Serial No. 60/171,741, filed Dec. 22, 1999, discloses an ABS system which is configured to monitor the condition of bearings, and this application is hereby incorporated herein in its entirety by reference. Monitoring such items as bearing health and tire pressure is important because such items are typically subject to malfunction and/or require maintenance, and may provide downtime for a trailer if not monitored.

In addition to ABS systems, many trailers include a Trailer Tracking (TT) system. As shown in FIG. 1, a TT system 30 typically includes suitable electronics 32 (hereinafter “TT electronics”), as well as a communications antenna 34 and a Global Positioning System (GPS) antenna 36, where both antennas are connected to the TT electronics. Although not specifically shown in FIG. 1, a TT system may also include several sensors which are connected to the TT electronics, such as a sensor for sensing whether the trailer is loaded or empty, a sensor for sensing whether the trailer door is opened or closed, and a sensor for sensing whether the trailer is coupled to a tractor.

The communications antenna 34 provides that the TT system 30 can communicate GPS information and/or sensor information to a remote location, such as to a fleet base. In this manner, a TT system keeps the fleet base updated about the location of the trailer, whether the trailer is loaded or empty, whether the trailer is coupled to a tractor, etc. The TT system on a trailer may be configured to communicate with a fleet base through a cellular network, in which case the communications antenna 34 comprises a cellular antenna, or through a constellation of Low Earth Orbit Satellites (LEOS), in which case the communications antenna 34 comprises a LEOS antenna.

In contrast to ABS electronics 26, TT electronics 32 are disposed near the front of a trailer 10, in what is commonly referred to as the nose cavity portion 40. The location of the TT electronics 32 is dictated by proximity to the GPS antenna 36 and also by the availability of space in the nose cavity portion 40 of the trailer 10. FIG. 1 shows the communications antenna 34 located on the roof 14 of the trailer 10, and this location is conventional. LEOS antennas are generally required to be located on the roof, and cellular antennas are typically provided in the same location.

Due to the general location of TT systems, they do not monitor things associated with the rear portion of the trailer, such as tire pressure, bearing health or anything to do with the braking system. Hence, trailers cannot communicate this type of information to a remote location, such as to a fleet base. Being able to monitor such information from a remote location would be advantageous because such items are typically subject to malfunction and/or require maintenance, and may provide downtime for a trailer. Therefore, being able to monitor such items from a remote location may avoid trailer downtime.

The present invention provides a novel braking system which has wireless communication capability. Other features and advantages will become apparent upon a reading of the attached specification, in combination with a study of the drawings.

### OBJECTS AND SUMMARY OF THE INVENTION

Accordingly, it is an object of an embodiment of the present invention to provide a braking system which is configured to communicate information in a wireless transmission to a remote location, such as to a fleet base.

Another object of an embodiment of the present invention is to provide a trailer with such a braking system.

Still another object of an embodiment of the present invention is to provide a trailer that includes a Trailer Tracking system and a braking system in communication with the Trailer Tracking system.

Briefly, and in accordance with one or more of the foregoing objects, an embodiment of the present invention provides a braking system, such as an Anti-Lock Brake System (ABS) or Electropneumatic Braking System (EBS), which is configured to communicate information in a wireless transmission to a remote location. The braking system may be provided on a trailer, and may be configured to communicate the information to a fleet base. The information which is communicated to the fleet base may include information regarding tire pressure and bearing health, as well as other information about the trailer. The braking system includes an Electronic Control Module, and the Electronic Control Module may be connected to a communications antenna for transmitting the information to the fleet base, or may be in communication with a Trailer Tracking system on the trailer, where the Trailer Tracking system is configured to transmit the information to the fleet base.

### BRIEF DESCRIPTION OF THE DRAWINGS

The organization and manner of the structure and function of the invention, together with further objects and advantages thereof, may be understood by reference to the following description taken in connection with the accompanying drawings, wherein:

FIG. 1 is a perspective view of a conventional trailer, showing the location of ABS electronics and TT electronics;

FIG. 2 is a schematic diagram of a system which is in accordance with an embodiment of the present invention;

FIG. 3 is a perspective view of a trailer, similar to FIG. 1, showing the system of FIG. 2 implemented in the trailer;

FIG. 4 is a schematic diagram of a system which is in accordance with another embodiment of the present invention; and

FIG. 5 is a perspective view of a trailer, similar to FIG. 1, showing the system of FIG. 4 implemented in the trailer.

### DETAILED DESCRIPTION OF ILLUSTRATED EMBODIMENTS

While the present invention may be susceptible to embodiment in different forms, there are shown in the drawings, and herein will be described in detail, embodiments of the invention with the understanding that the present description is to be considered an exemplification of the principles of the invention and is not intended to limit the invention to that as illustrated and described herein.

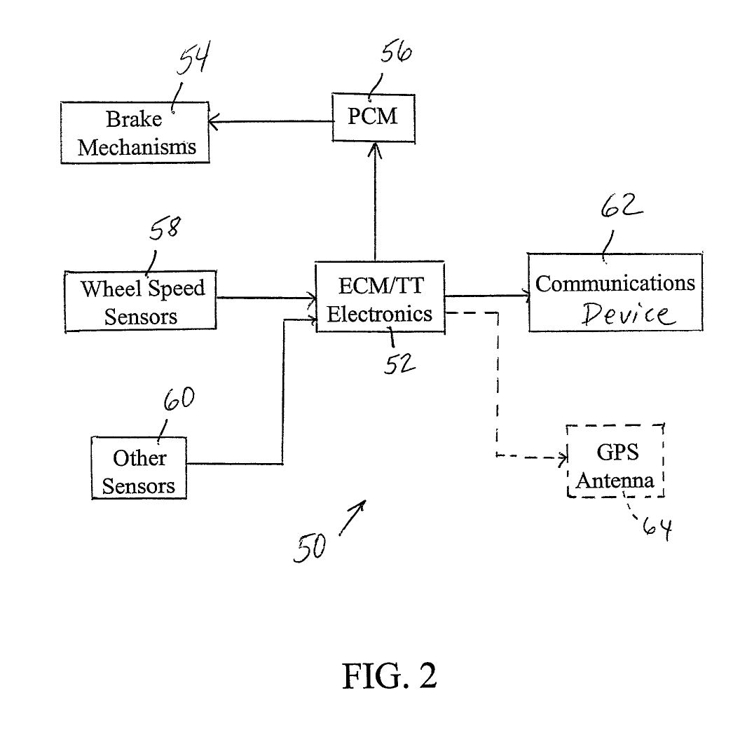

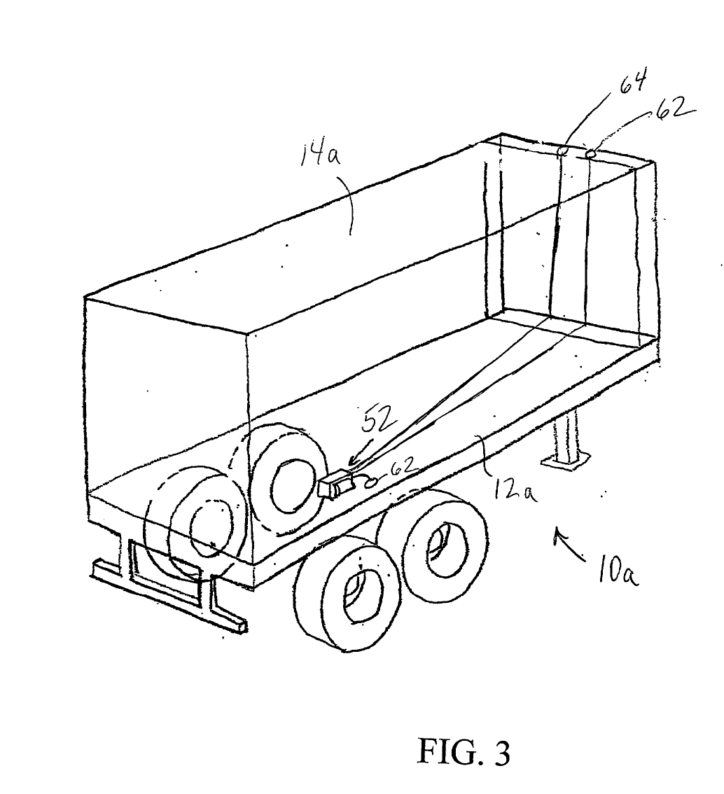

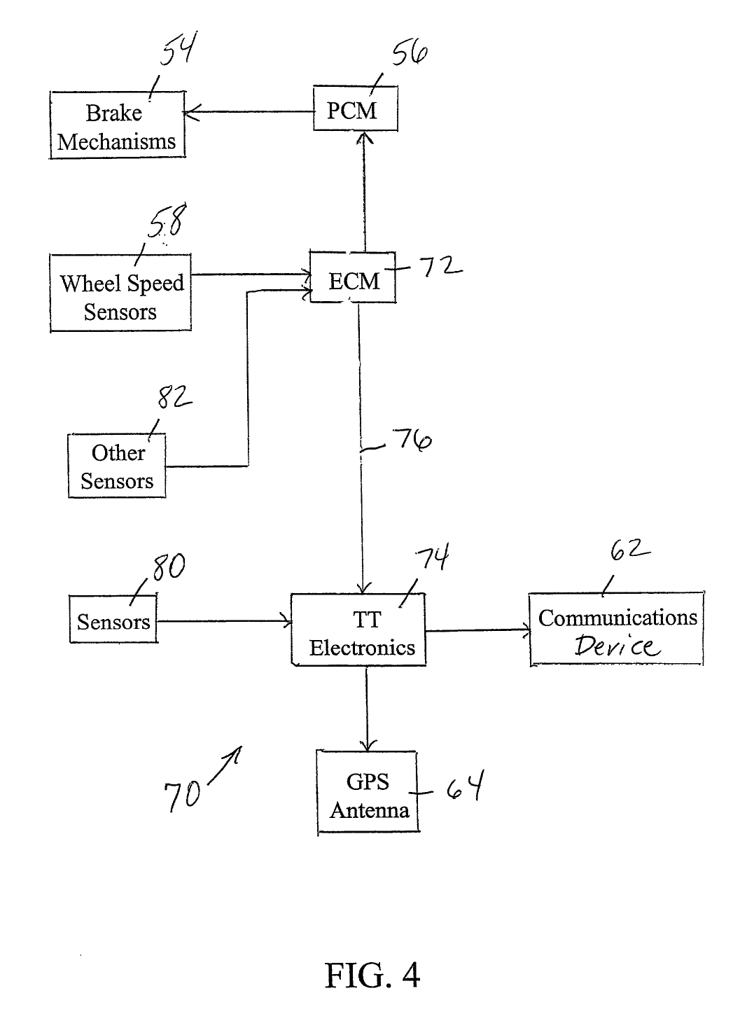

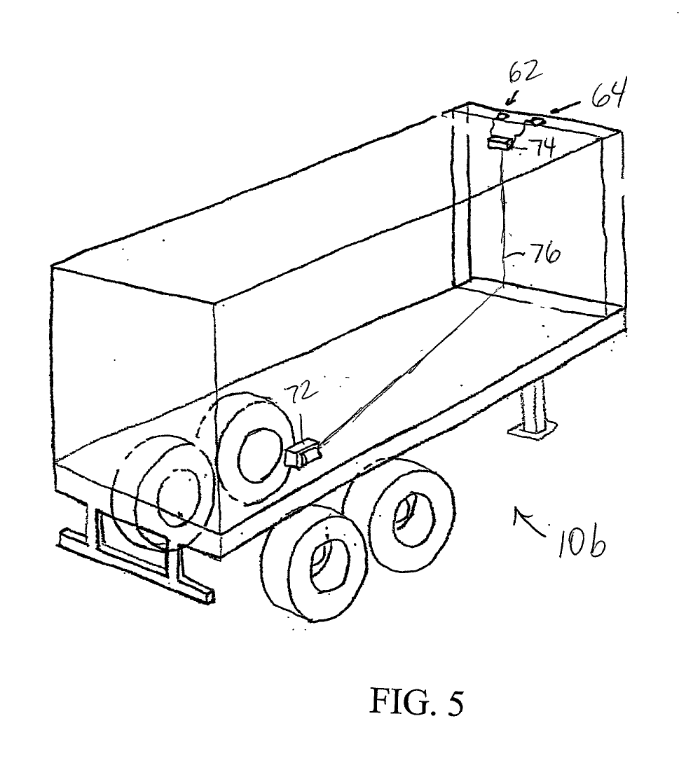

FIGS. 2 and 4 illustrate systems 50, 70 which are in accordance with embodiments of the present invention, and FIGS. 3 and 5 show each of these systems 50, 70, respectively, provided on a trailer 10a, 10b. Each system provides that certain information which is not otherwise generally transmitted to a remote location, such as information regarding bearing health and tire pressure, is transmitted to a remote location, such as to a fleet base. As a result, a fleet base can remain updated regarding certain aspects about items that may require maintenance and/or repair. Hence, trailer downtime can be avoided.

The system 50 illustrated in FIG. 2 will now be described. The system includes a braking system, and the braking system may comprise, for example, an Anti-Lock Brake System (ABS) or Electropneumatic Braking System (EBS). The braking system provides that Electronic Control Module (ECM) electronics and Trailer Tracking (TT) electronics are effectively merged into ECM/TT electronics 52, perhaps in a single module. This avoids the cost of having to provide two separate modules.

The braking system includes brake mechanisms 54, such as air-brake mechanisms, and a Pneumatic Control Module (PCM) 56 connected to and configured to control the brake mechanisms 54. The system also includes wheel speed sensors 58 which are in communication with the ECM/TT electronics 52. The wheel speed sensors 58 provide wheel speed information to the ECM/TT electronics 52, and the ECM/TT electronics 52 signal the PCM 56 to operate the brake mechanisms 54 accordingly. This process preferably controls the braking level so that the wheels continue to rotate, or at least rotate most of the time, even during heavy braking.

As shown in FIG. 2, other sensors 60 may be in communication with the ECM/TT electronics 52. Such sensors 60 may include one or more sensors for monitoring tire pressure as well as one or more sensors for monitoring bearing health (see U.S. Provisional Application Serial No. 60/171,741, filed Dec. 22, 1999, which has been incorporated herein). The sensors in communication with the ECM/TT electronics 52 also preferably include one or more sensors which are typically associated with TT systems, such as one or more sensors for monitoring whether a trailer is connected to a tractor, whether a trailer is loaded or empty, and whether a door of the trailer is opened or closed.

The ECM/TT electronics 52 is connected to a communications device 62, such as to a communications antenna and corresponding structure. If the braking system is configured to communicate through a cellular network, the communication device 62 may include a cellular antenna and comprise an implementation of a data communication cell phone. This could be implemented either as a complete board level phone, or else as a cellular phone chip set for tighter integration into the ECM/TT electronics 52.

On the other hand, if the braking system is configured to communicate through a constellation of Low Earth Orbit Satellites (LEOS), the communication -antenna may comprise a LEOS antenna. Still further, if the braking system is configured to communicate in short range radio frequency (RF), the communications device 62 may comprise an RF communications device. In ,such case, the RF communications device may be configured to activate as it comes in range of the local terminal and alert maintenance personnel of any problems which may have been detected by the ECM/TT electronics 52.

Regardless, preferably the ECM/TT electronics 52 and communications device 62 are configured such that the braking system can communicate information in a wireless transmission, such as to a fleet base. Such information may include information about the braking system and/or information regarding the other sensors 60. As discussed above, the other sensors 60 may include one or more sensors for monitoring tire pressure as well as one or more sensors for monitoring bearing health. Hence, the ECM/TT electronics 52 and communications device 62 may be configured such that the braking system can communicate information regarding bearing health and tire pressure, in a wireless transmission, to the fleet base.

As shown in FIG. 2, the ECM/TT electronics 52 may also be connected to a Global Positioning System (GPS) antenna 64 (shown in phantom). In such case, the ECM/TT electronics 52 and communications device 62 are preferably configured such that the braking system can communicate information regarding location, in a wireless transmission, to the fleet base. The system 50 may not include the GPS antenna 64 because for certain applications, location and real time usage information may not be very important. An example is a Less Than (truck)Load (LTL) carrier operating a trailer on a fixed daily run between two cities.

FIG. 3 illustrates some of the components of the system 50 of FIG. 2 incorporated in a trailer 10a. As shown in FIG. 3, the communications device 62 (i.e. the antenna) may be disposed under the floor 12a of the trailer 10a, or on the roof 14a. If the braking system is configured to communicate through a cellular network, the communication device 62 may comprise a cellular antenna disposed under the trailer. The cellular antenna can be located proximate the ECM/TT module, if the ECM/TT electronics 52 is provided in the form of a single module, or the antenna can be integrated into a wiring harness associated with the module. On the other hand, if the braking system is configured to communicate through a constellation of Low Earth Orbit Satellites (LEOS) or through short range Radio Frequency (RF), the communication antenna may comprise a LEOS or RF antenna, respectively, which is disposed on the roof of the trailer. As shown in FIG. 3, preferably if a GPS antenna 64 is provided, the GPS antenna 64 is disposed generally on the roof 14a of the trailer 10a.

The trailer 10a shown in FIG. 3, as a result of incorporating the system 50 shown in FIG. 2, is configured to communicate information in a wireless transmission, to a remote location, such as to a fleet base, and the information includes information which is not ordinarily transmittable by a trailer to a remote location. As described above, such information may include information regarding the brake system of the trailer, bearing health and/or tire pressure. Such items are generally subject to maintenance or repair. Therefore, it is important for a fleet base to remain updated about these types of items so as to avoid trailer downtime.

If the fleet base becomes aware, as a result of the wireless transmission, of a problem with the trailer 10a, the fleet base can arrange to have the trailer 10a serviced immediately when it reaches its destination terminal, or the driver of the trailer 10a could be contacted, possibly over a cell phone, if there is a major problem.

The system 70 illustrated in FIG. 4 is functionally very much like the system 50 shown in FIG. 2, except that instead of providing that the ECM and TT electronics are effectively merged (perhaps in a single module) as shown in FIG. 2, the system 70 illustrated in FIG. 4 provides that the ECM 72 is in communication with the TT electronics 74. The means of communication between the ECM and TT electronics may consist of a wired or wireless connection 76.

Much like the system 50 shown in FIG. 2, the system 70 shown in FIG. 4 includes brake mechanisms 54, a PCM 56 and wheel speed sensors 58. The system 70 provides that the sensors 80 which are ordinarily associated with a TT system are in communication with the TT electronics 74. As described above, such sensors 80 may include one or more sensors for sensing whether a tractor is connected to a trailer, one or more sensors for sensing whether the door of a trailer is opened or closed, and one or more sensors for sensing whether the trailer is loaded or empty.

In addition to the wheel speed sensors 58, other sensors 82 may be in communication with the ECM 72. Such other sensors 82 may include one or more sensors for monitoring bearing health and one or more sensors for monitoring tire pressure. The system provides that a communications antenna 62 and possibly a GPS antenna 64 is connected to the TT electronics 74.

As discussed above, the system 70 illustrated in FIG. 4 provides that the ECM 72 is in communication with the TT electronics 74. More specifically, the ECM 72 is configured such that it can communicate information to the TT electronics 74, and the TT electronics 74 can thereafter use the communications device 62 to transmit the information in a wireless transmission to a remote location, such as to a fleet base. Such information may include brake information or information regarding the other sensors, such as bearing health information and/or information regarding tire pressure.

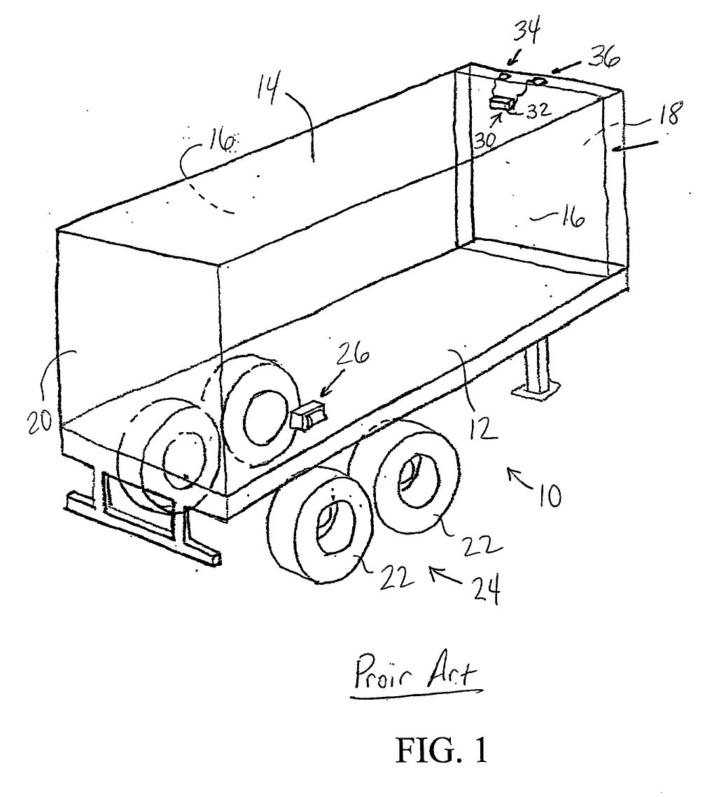

FIG. 5 illustrates some of the components of the system 70 of FIG. 4 incorporated in a trailer 10b. As shown in FIG. 5, the trailer 10b is similar to the trailer 10 shown in FIG. 1, except the trailer 10b shown in FIG. 5 does not provide that the braking system and TT system are entirely independent from each other. Instead, the trailer 10b shown in FIG. 5 provides that the braking system (i.e., the ECM 72) is in communication with the TT system (i.e., the TT electronics 74). This provides that the TT system can communicate information which is not ordinarily transmittable by a trailer to a remote location. As described above, such information may include information regarding the brake mechanisms of the trailer, bearing health and/or tire pressure. Such items are generally subject to maintenance or repair. Therefore, it is important for a fleet base to remain updated about these types of items so as to avoid trailer downtime.

It is understood that, in the future, ABS control functions may be incorporated into a comprehensive Electropneumatic Braking System (EBS). The concepts disclosed herein could apply not only to an ABS system, but also to the integration of a communication device into an EBS electronic module.

While embodiments of the present invention are shown and described, it is envisioned that those skilled in the art may devise various modifications without departing from the spirit and scope of the foregoing description.

The invention claimed is:

1. A braking system comprising: brake mechanisms; and electronics connected to the brake mechanisms and configured to communicate information in a wireless transmission to a remote location.

2. A braking system as recited in claim 1, further comprising a communications device, and wherein said electronics comprises an Electronic Control Module connected to said communications device.

3. A braking system as recited in claim 2, wherein said communications device comprises a communications antenna.

4. A braking system as recited in claim 1, further comprising a communications device, wherein said electronics comprises a Pneumatic Control Module connected to the brake mechanisms, and an Electronic Control Module connected to the Pneumatic Control Module and to said communications device.

5. A braking system as recited in claim 1, further comprising a communications device and a plurality of wheel speed sensors, wherein said electronics comprises a Pneumatic Control Module connected to the brake mechanisms, and an Electronic Control Module connected to the Pneumatic Control Module, to said wheel speed sensors and to said communications device.

6. A braking system as recited in claim 1, further comprising a Trailer Tracking system, said electronics configured to communicate information to said Trailer Tracking system.

7. A braking system as recited in claim 6, wherein said electronics is physically wired to said Trailer Tracking system.

8. A braking system as recited in claim 6, wherein said electronics is configured to communicate with said Trailer Tracking system in a wireless transmission.

9. A braking system as recited in claim 5, said braking system configured to monitor tire pressure, said electronics configured to communicate information regarding tire pressure to the remote location.

10. A braking system as recited in claim 5, said braking system configured to monitor bearing health, said electronics configured to communicate information regarding bearing health to the remote location.

11. A braking system as recited in claim 5, said braking system configured to monitor tire pressure and bearing health, said electronics configured to communicate information regarding tire pressure and bearing health to the remote location.

12. A braking system comprising: brake mechanisms; a Pneumatic Control Module connected to the brake mechanisms; an antenna; a plurality of wheel speed sensors; an Electronic Control Module connected to said wheel speed sensors, to said Pneumatic Control Module and to said antenna, said Electronic Control Module configured to communicate information in a wireless transmission to a remote location.

13. A braking system as recited in claim 12, said braking system configured to monitor tire pressure, said electronics configured to communicate information regarding tire pressure to the remote location.

14. A braking system as recited in claim 12, said braking system configured to monitor bearing health, is said electronics configured to communicate information regarding bearing health to the remote location.

15. A braking system as recited in claim 12, said braking system configured to monitor tire pressure and bearing health, said electronics configured to communicate information regarding tire pressure and bearing health to the remote location.

16. A braking system as recited in claim 12, further comprising a Trailer Tracking system, said Electronic Control Module connected to said Trailer Tracking system.

17. A braking system as recited in claim 12, wherein said electronics is physically wired to said Trailer Tracking system.

18. A braking system as recited in claim 12, further comprising a Trailer Tracking system, said Electronic Control Module configured to communicate with said Trailer Tracking system in a wireless transmission.

19. A trailer comprising: a braking system configured to communicate information in a wireless transmission to a remote location.

20. A trailer as recited in claim 19, said braking system configured to monitor tire pressure and communicate information regarding tire pressure to the remote location.

21. A trailer as recited in claim 19, said braking system configured to monitor bearing health and communicate information regarding bearing health to the remote location.

22. A trailer as recited in claim 19, said braking system configured to monitor tire pressure and bearing health and communicate information regarding tire pressure and bearing health to the remote location.

23. A trailer as recited in claim 19, said braking system comprising brake mechanisms, and electronics connected to the brake mechanisms and configured to communicate information to the remote location.

24. A trailer as recited in claim 23, said braking system further comprising a communications device, and wherein said electronics comprises an Electronic Control Module connected to said communications device.

25. A trailer as recited in claim 24, wherein said communications device comprises a communications antenna.

26. A trailer as recited in claim 23, said braking system further comprising a communications device, wherein said electronics comprises a Pneumatic Control Module connected to the brake mechanisms, and an Electronic Control Module connected to the Pneumatic Control Module and to said communications device.

27. A trailer as recited in claim 23, said braking system further comprising a communications device and a plurality of wheel speed sensors, wherein said electronics comprises a Pneumatic Control Module connected to the brake mechanisms, and an Electronic Control Module connected to the Pneumatic Control Module, to said wheel speed sensors and to said communications device.

28. A trailer as recited in claim 23, further comprising a Trailer Tracking system, said electronics configured to communicate information to said Trailer Tracking system.

29. A trailer as recited in claim 28, wherein said electronics is physically wired to said Trailer Tracking system.

30. A trailer as recited in claim 28, wherein said electronics is configured to communicate with said Trailer Tracking system in a wireless transmission.

31. A trailer comprising: a Trailer Tracking system; and a braking system in communication with said Trailer Tracking system.
